(19) United States
(12) Patent Application Publication
(10) Pub. No.: US 2025/0053046 A1
(43) Pub. Date: Feb. 13, 2025

(54) WRITABLE DEVICE

(71) Applicant: InnoLux Corporation, Miao-Li County (TW)

(72) Inventors: Chih-Chin KUO, Miao-Li County (TW); Hsu-Kuan HSU, Miao-Li County (TW)

(21) Appl. No.: 18/764,984

(22) Filed: Jul. 5, 2024

(30) Foreign Application Priority Data
Aug. 11, 2023 (CN) 202311011826.3

(51) Int. Cl. G02F 1/1337; G02F 1/1339; G02F 1/137

(52) U.S. Cl. CPC G02F 1/133746; G02F 1/13398; G02F 1/13718

(57) ABSTRACT

A writable device is provided. The writable device includes a first substrate, a second substrate, a liquid-crystal layer, a first alignment layer and a second alignment layer. The second substrate is opposite to the first substrate. The liquid-crystal layer is disposed between the first substrate and the second substrate. The first alignment layer is disposed between the first substrate and the liquid-crystal layer. The second alignment layer is disposed between the second substrate and the liquid-crystal layer. The first alignment layer and the second alignment layer are vertically oriented. In its initial state, the liquid-crystal layer is in a transparent state. In the writing state, the liquid-crystal layer corresponding to the pressed writing area is in a scattering state. In its clear state, at least a part of the liquid-crystal layer corresponding to the pressed writing area is in the transparent state.

### CROSS REFERENCE TO RELATED APPLICATIONS

This application claims priority of China Patent Application No. 202311011826.3, filed on Aug. 11, 2023, the entirety of which is incorporated by reference herein.

### BACKGROUND

### Field of the Invention

The present invention relates to a writable device, and, in particular, to a writable device that includes vertically oriented alignment layers.

### Description of the Related Art

Due to the booming development of technology, usage of electronic devices is becoming more and more popular nowadays, and writable devices have gradually become favored by consumers. How to reduce the operation time of writable devices during writing or clearing is one of the issues which need to be improved.

### BRIEF SUMMARY

An embodiment of the present invention provides a writable device including a first substrate, a second substrate, a liquid-crystal layer, a first alignment layer and a second alignment layer. The second substrate is opposite to the first substrate. The liquid-crystal layer is disposed between the first substrate and the second substrate. The first alignment layer is disposed between the first substrate and the liquid-crystal layer. The second alignment layer is disposed between the second substrate and the liquid-crystal layer. The first alignment layer and the second alignment layer are vertically oriented. In its initial state, the liquid-crystal layer is in a transparent state. In the writing state, the liquid-crystal layer corresponding to the pressed writing area is in a scattering state. In its clear state, at least a part of the liquid-crystal layer corresponding to the pressed writing area is in the transparent state.

### BRIEF DESCRIPTION OF THE DRAWINGS

The present invention can be more fully understood by reading the subsequent detailed description and examples with references made to the accompanying drawings, wherein:

FIG. 1A shows a schematic cross-sectional view of a writable device in its initial state in accordance with some embodiments of the present disclosure.

FIG. 1B shows a schematic cross-sectional view of the writable device in a writing state in accordance with some embodiments of the present disclosure.

FIG. 1C shows a schematic cross-sectional view of the writable device in a clear state in accordance with some embodiments of the present disclosure.

FIG. 2A shows a partially enlarged schematic view of the writable device in accordance with some embodiments of the present disclosure.

FIG. 2B shows a partially enlarged schematic view of the writable device in accordance with some embodiments of the present disclosure.

FIG. 3 shows a schematic cross-sectional view of the writable device in accordance with some embodiments of the present disclosure.

FIGS. 4A to 4B show schematic cross-sectional views of the writable device in accordance with some embodiments of the present disclosure.

FIGS. 5A to 5B show schematic cross-sectional views of the writable device in accordance with some embodiments of the present disclosure.

FIGS. 6A to 6B show schematic cross-sectional views of the writable device in accordance with some embodiments of the present disclosure.

FIGS. 7A to 7B show schematic cross-sectional views of the writable device in accordance with some embodiments of the present disclosure; and

FIG. 8 shows a schematic cross-sectional view of the writable device in accordance with some embodiments of the present disclosure.

### DETAILED DESCRIPTION

The present disclosure may be understood by referring to the following description and the appended drawings. It should be noted that, in order to make it easy for the reader to understand and to make the drawings concise, the drawings in the present disclosure may illustrate a part of the light-emitting unit, and specific elements in the drawings are not drawn based on the actual scale. In addition, the number and the size of each component in the drawings merely serves as an example, and are not intended to limit the scope of the present disclosure. Furthermore, similar and/or corresponding numerals may be used in different embodiments for describing some embodiments simply and clearly, but not represent any relationship between different embodiment and/or structures discussed below.

Certain terms may be used throughout the present disclosure and the appended claims to refer to particular elements. Those skilled in the art will understand that electronic device manufacturers may refer to the same components by different names. The present specification is not intended to distinguish between components that have the same function but different names. In the following specification and claims, the words “including”, “comprising”, “having” and the like are open words, so they should be interpreted as meaning “including but not limited to . . . ”. Therefore, when terms “including”, “comprising”, and/or “having” are used in the description of the disclosure, the presence of corresponding features, regions, steps, operations and/or components is specified without excluding the presence of one or more other features, regions, steps, operations and/or components.

In addition, in this specification, relative expressions may be used. For example, “lower”, “bottom”, “higher” or “top” are used to describe the position of one element relative to another. It should be noted that if a device is flipped upside down, an element that is “lower” will become an element that is “higher”.

When a corresponding component (such as a film layer or region) is referred to as “on another component”, it may be directly on another component, or there may be other components in between. On the other hand, when a component is referred “directly on another component”, there is no component between the former two. In addition, when a component is referred “on another component”, the two components have an up-down relationship in the top view, and this component can be above or below the other component, and this up-down relationship depends on the orientation of the device.

It should be understood that, although the terms “first”, “second” etc. may be used herein to describe various elements, layers and/or portions, and these elements, layers, and/or portions should not be limited by these terms. These terms are only used to distinguish one element, layer, or portion. Thus, a first element, layer or portion discussed below could be termed a second element, layer or portion without departing from the teachings of some embodiments of the present disclosure. In addition, for the sake of brevity, terms such as “first” and “second” may not be used in the description to distinguish different elements. As long as it does not depart from the scope defined by the appended claims, the first element and/or the second element described in the appended claims can be interpreted as any element that meets the description in the specification.

In the present disclosure, the thickness, length, and width can be measured by using an optical microscope, and the thickness can be measured by the cross-sectional image in the electron microscope, but it is not limited thereto. In addition, a certain error may be present in a comparison with any two values or directions. The terms “about,” “equal to,” “equivalent,” “the same,” “essentially” or “substantially” are generally interpreted as within 10% of a given value or range, or as interpreted as within 5%, 3%, 2%, 1%, or 0.5% of a given value or range. In addition, the term “electrically connected” may be used below. It should be understood that if the present disclosure recites “the first element is electrically connected to the second element,” it may be interpreted as that the first element and the second element are electrically connected to each other and may be synchronously controlled by a single operation, which may include the case “there may be other elements between the first element and the second element to electrically connect the former two,” or include “the first element and the second element are directly electrically connected without other elements.” When it is mentioned in the present disclosure that the first element is “directly electrically connected” to the second element, it may be taken to mean that “the first element and the second element are directly electrically connected without other elements.” In addition, the term “electrically insulated” may be used below. It should be understood that if the present disclosure recites “the first element and the second element are electrically insulated,” it may be interpreted as that the first element and the second element are electrically separated without being connected to each other, nor synchronously controlled by a single operation.

It should be noted that the technical solutions provided by different embodiments below may be interchangeable, combined or mixed to form another embodiment without departing from the spirit of the present disclosure.

Unless defined otherwise, all terms (including technical and scientific terms) used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined in the present disclosure.

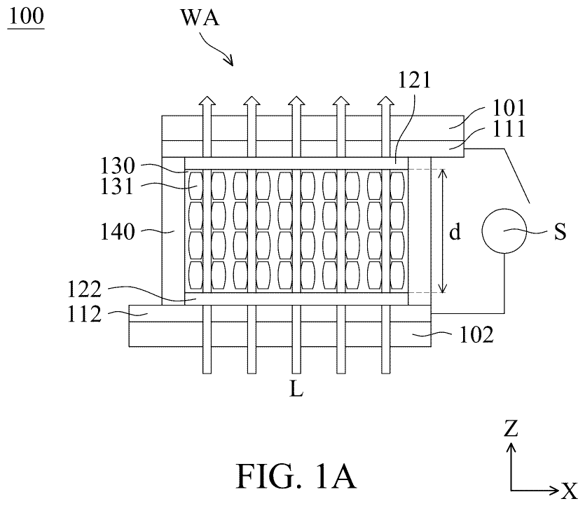

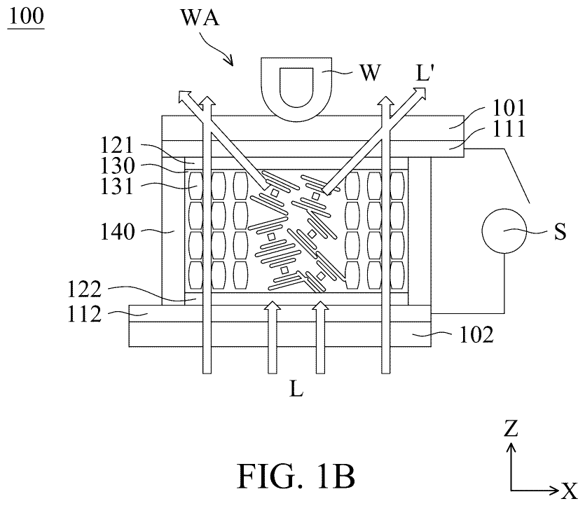

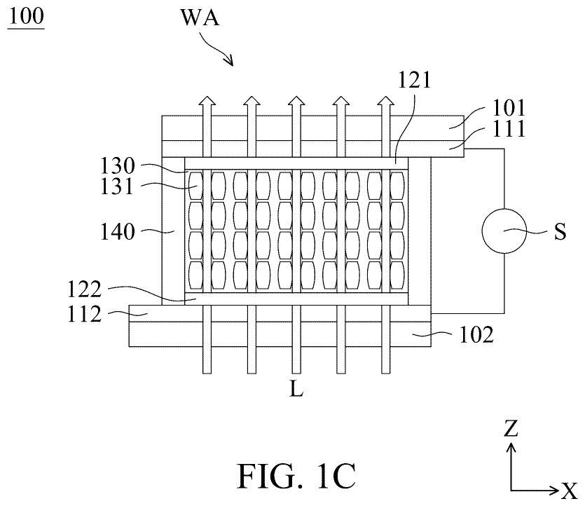

FIG. 1A shows a schematic cross-sectional view of a writable device 100 in accordance with some embodiments of the present disclosure. The writable device 100 may be disposed on the following elements, for example, a display device, a backlight device, an antenna device, a sensing device or a splicing device, but the present disclosure is not limited thereto. The writable device 100 may be a bendable or flexible electronic device. The display device may be a non-self-luminous display device or a self-luminous display device. The antenna device may be a liquid-crystal type antenna device or a non-liquid-crystal type antenna device. The sensing device may be a sensing device for sensing capacitance, light, thermal energy or ultrasonic waves, but the present disclosure is not limited thereto. In some embodiments, the writable device 100 includes a flexible panel, and the flexible panel includes electronic components, and the electronic components may include passive components and active components, such as capacitors, resistors, inductors, diodes, transistors, and the like. In some embodiments, the electronic device may include, for example, a diode, a liquid-crystal, a light-emitting diode (LED), a quantum dot (QD), fluorescence, phosphorescence (phosphor), other suitable display media, or a combination thereof. In some embodiments, the diodes may include light-emitting diodes or photodiodes. The light-emitting diodes may, for example, include organic light-emitting diodes (OLEDs), mini LEDs, micro LEDs or quantum dot LEDs, but the present disclosure is not limited thereto. The splicing device may be, for example, a display splicing device or an antenna splicing device, but the present disclosure is not limited thereto. It should be noted that the writable device 100 may be any combination of the above-mentioned devices, but the present disclosure is not limited thereto. In addition, the shape of the writable device 100 may be rectangular, circular, polygonal, shapes with curved edges or other suitable shapes. The writable device 100 may have peripheral systems such as drive systems, control systems, and light source systems to support display devices, antenna devices, wearable devices (such as including augmented reality or virtual reality), vehicle-mounted devices (such as including car windshields), or splicing devices.

It should be understood that the content of the present disclosure will be discussed with respect to the partial structure (such as a pressed writing area WA) of the writable device 100 in the following paragraphs, and those skilled in the art should understand that the writable device 100 may also include other structures or be equipped with suitable electronic components to perform expected functions.

As shown in FIG. 1A, the writable device 100 may include a first substrate 101, a second substrate 102, a first conductive layer 111, a second conductive layer 112, a first alignment layer 121, a second alignment layer 122 and a liquid-crystal layer 130 that is disposed between the first alignment layer 121 and the second alignment layer 122. In some embodiments, the second substrate 102 may be opposite the first substrate 101. For example, the first substrate 101 and the second substrate 102 may include glass, polymer materials (such as polyethylene terephthalate (PET), polycarbonate (PC), triacetyl cellulose (TAC), polyimide (PI), etc.), ceramics or other suitable transparent materials, but the present disclosure is not limited thereto. In some embodiments, the thickness of the first substrate 101 or the second substrate 102 may be greater than or equal to 0.2 mm and less than or equal to 30 mm, but the present disclosure is not limited thereto. In some embodiments, the thickness of the first substrate 101 or the second substrate 102 may be greater than or equal to 0.2 mm and less than or equal to 10 mm. In some embodiments, the thickness of the first substrate 101 or the second substrate 102 may be greater than or equal to 0.2 mm and less than or equal to 5 mm. In some embodiments, the thickness of the first substrate 101 or the second substrate 102 may be greater than or equal to 0.2 mm and less than or equal to 1 mm. In some embodiments, the thickness of the first substrate 101 or the second substrate 102 may be greater than or equal to 0.2 mm and less than or equal to 0.8 mm. In some embodiments, the thickness of the first substrate 101 or the second substrate 102 located on the pressing side of the writable device 100 may be greater than or equal to 0.2 mm and less than or equal to 1 mm or 0.8 mm to improve the sensitivity of pressing the writable device 100. However, the present disclosure is not limited thereto. By setting the thickness of the first substrate 101 or the second substrate 102 located on the pressing side of the writable device 100 within the above range, the sensitivity of pressing the writable device 100 can be improved. In some embodiments, the thicknesses of the first substrate 101 and the second substrate 102 may be the same or different from each other.

In some embodiments, the liquid-crystal layer 130 is disposed between the first substrate 101 and the second substrate 102. The first alignment layer 121 is disposed between the first substrate 101 and the liquid-crystal layer 130, and the second alignment layer 122 is disposed between the second substrate 102 and the liquid-crystal layer 130. In some embodiments, the liquid-crystal layer 130 includes a plurality of liquid-crystal molecules 131. For example, the liquid-crystal layer 130 may include cholesteric liquid-crystal (CLC), polymer-stabilized cholesteric texture (PSCT) or other dispersed liquid-crystals, but the present disclosure is not limited thereto. In some embodiments, the liquid-crystal layer 130 includes cholesteric positive liquid-crystal, and the first alignment layer 121 and/or the second alignment layer 122 are, for example, vertically oriented. In such case, the liquid-crystal layer 130 may be transparent when it is in its initial state, when it is the clear state, or when it is in both of those states simultaneously. In some embodiments, at least one dye is added to the liquid-crystal layer 130 so that the liquid-crystal layer 130 corresponding to the pressed writing area WA can show the color of the dye, such as black, red, yellow, green, blue or any suitable color. In some embodiments, multiple dyes of different colors are added to the liquid-crystal layer 130. This embodiment can make the liquid-crystal layer 130 corresponding to the pressed writing area WA appear close to white or other suitable colors, but the present disclosure is not limited thereto. In some embodiments, the birefringence (Δn=ne-no) of the liquid-crystal layer 130 may be greater than or equal to 0.15 and less than or equal to 0.4, but the present disclosure is not limited thereto. In some embodiments, the birefringence (Δn=ne-no) of the liquid-crystal layer 130 may be greater than or equal to 0.15 and less than or equal to 0.35. In some embodiments, the birefringence (Δn=ne-no) of the liquid-crystal layer 130 may be greater than or equal to 0.15 and less than or equal to 0.3.

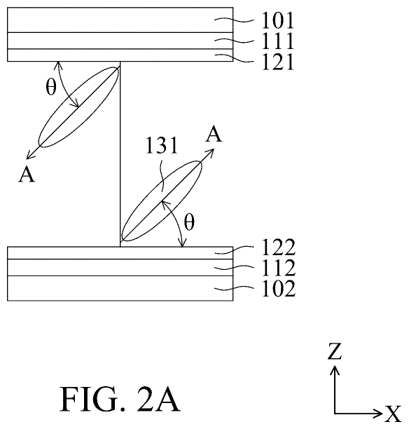

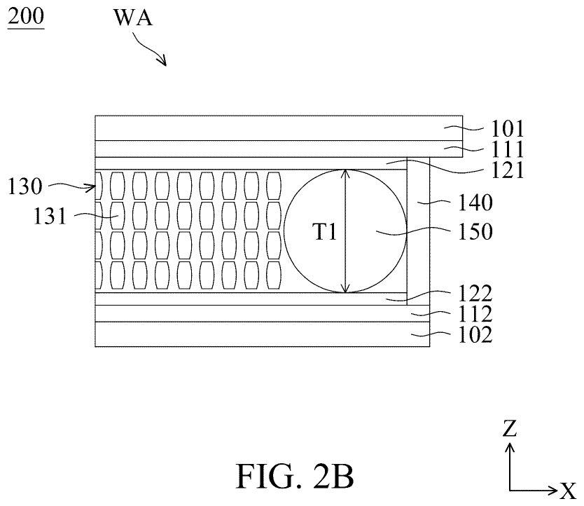

In the present embodiment, the first alignment layer 121 and the second alignment layer 122 may be vertically oriented, so that the liquid-crystal molecules 131 of the liquid-crystal layer 130 disposed between the first alignment layer 121 and the second alignment layer 122 may be arranged approximately at an angle along the alignment direction. The definition of the alignment direction and the angle of the first alignment layer 121 and the second alignment layer 122 will be further described below with reference to FIG. 2A. In some embodiments, a sealant 140 may be disposed between the first substrate 101 and the second substrate 102. The sealant 140, for example, surrounds the liquid-crystal layer 130. The sealant 140 seals the liquid-crystal layer 130 in the space formed by the first substrate 101, the second substrate 102 and the sealant 140.

In some embodiments, the first alignment layer 121 and the second alignment layer 122 are separated by a distance d in the normal direction of the first substrate 101 (Z-axis direction), and the liquid-crystal molecules 131 may have a distance d. Pitch, the ratio of the distance d to the pitch of the liquid-crystal molecules 131 is greater than or equal to 5 and less than or equal to 20, but is not limited thereto. In some embodiments, the ratio of the distance d to the pitch of the liquid-crystal molecules 131 is greater than or equal to 7 and less than or equal to 18. In some embodiments, the ratio of the distance d to the pitch of the liquid-crystal molecules 131 is greater than or equal to 8 and less than or equal to 17. In some embodiments, the ratio of the distance d to the pitch of the liquid-crystal molecules 131 is greater than or equal to 10 and less than or equal to 15. In some embodiments, the distance d between the first alignment layer 121 and the second alignment layer 122 can be obtained by, for example, measuring and averaging the distance between the first alignment layer 121 and the second alignment layer 122 at any three locations in the normal direction (Z-axis).

In some embodiments, the pitch of the liquid-crystal molecules 131 can be obtained, for example, in the following manner, but the present disclosure is not limited thereto. For example, a reference liquid-crystal with a known pitch and the liquid-crystal molecules 131 to be measured can be dropped into a wedge cell respectively. By comparing the image intervals between the reference liquid-crystal and the liquid-crystal molecules 131 in a microscope, the pitch of the liquid-crystal molecules 131 can be calculated in proportion to the pitch of the reference liquid-crystal. The above-mentioned measurement method is merely an example. Any method that may obtain the pitch of the liquid-crystal molecules 131 and the resulting values are included within the scope of the present disclosure. With the arrangement of the above-mentioned distance d and the pitch of the liquid-crystal molecules 131, the color of the writable device 100 can be darker during writing, thereby improving the legibility of the written information. The written color can be tuned, for example, according to the color of the dye added to the liquid-crystal layer 130. If the value of the distance d and the pitch of the liquid-crystal molecules 131 are too large and exceed the above range, the liquid-crystal molecules 131 may not be easily restored by the electric field, making it difficult for the writable device 100 to revert to its initial state.

In some embodiments, the first conductive layer 111 is disposed between the first substrate 101 and the first alignment layer 121, and the second conductive layer 112 is disposed between the second substrate 102 and the second alignment layer 122. In other words, the first alignment layer 121 is disposed between the first conductive layer 111 and the liquid-crystal layer 130. For example, the first conductive layer 111 and the first conductive layer 112 may include metal or other suitable conductive materials (such as indium tin oxide (ITO), chromium (Cr), indium zinc oxide (IZO), etc.), but the present is not limited thereto. In some embodiments, the first conductive layer 111 and the second conductive layer 112 may be selectively electrically connected or not electrically connected to the power source S. The first conductive layer 111 and the second conductive layer 112 are electrically connected to the power supply S, which means there may be a potential difference between the first conductive layer 111 and the second conductive layer 112 to form a vertical electric field, and the intensity of the vertical electric field may vary according to the potential difference between the first conductive layer 111 and the second conductive layer 112, thereby controlling the arrangement of the liquid-crystal layer 130. The first conductive layer 111 and the second conductive layer 112 are not electrically connected to the power source S, which means that there is no potential difference between the first conductive layer 111 and the second conductive layer 112 to form any vertical electric field.

As shown in FIG. 1A, in the initial state, the first conductive layer 111 and the second conductive layer 112 are not electrically connected to the power supply S (that is, there is an open circuit among the first conductive layer 111, the second conductive layer 112 and the power supply S). In the initial state, the liquid-crystal layer 130 is in a transparent state. Specifically, in the initial state, the liquid-crystal molecules 131 of the liquid-crystal layer 130 are generally arranged along the alignment direction. At this time, most of the incident light L passing through the second substrate 102 can travel to the first substrate 101 via the liquid-crystal layer 130. That is, for example, the incident light L can mostly pass through the first substrate 101, so the liquid-crystal layer 130 of the writable device 100 in the initial state can be in the transparent state.

FIG. 1B shows a schematic cross-sectional view of the writable device 100 in the writing state in accordance with some embodiments of the present disclosure. As shown in FIG. 1B, in the writing state, the liquid-crystal layer 130 corresponding to the pressed writing area WA is in a scattering state. Specifically, in the writing state, for example, the first conductive layer 111 and the second conductive layer 112 are not electrically connected to the power supply S (that is, there is an open circuit among the first conductive layer 111, the second conductive layer 112 and the power supply S). At this time, a part of the liquid-crystal layer 130 affected by the pressing W, for example, changes its arrangement and is in the scattering state. That is, the liquid-crystal layer 130 corresponding to the pressed writing area WA is in the scattering state. To be more specific, the pressing W from users may affect the arrangement of the liquid-crystal molecules 131 in the liquid-crystal layer 130, for example, causing the liquid-crystal molecules 131 to be arranged in a scattering or irregular manner and therefore in the scattering state. As a result, the incident light L passing through the pressed writing area WA is scattered, for example. With the above design, the pressed writing area WA can be made to appear in a mist state, while the liquid-crystal molecules 131 outside the pressed writing area WA can be in the transparent state, thereby achieving the writing function. In some embodiments, when at least one dye is added to the liquid-crystal layer 130, since the macro axis of the dye may be arranged along the macro axis of the liquid-crystal molecules 131, the incident light L corresponding to the pressed writing area WA is mostly absorbed by the dyes arranged in a scattering or irregular manner, and only the light corresponding to the dye color is not absorbed and passes through. Meanwhile, the corresponding pressed writing area WA shows the color of the dye, and outside the pressed writing area WA is in the transparent state, thereby achieving the writing effect. However, the present disclosure is not limited thereto.

FIG. 1C shows a schematic cross-sectional view of the writable device 100 in the clear state in accordance with some embodiments of the present disclosure. As shown in FIG. 1C, in the clear state, the first conductive layer 111 and the second conductive layer 112 are electrically connected to the power source S (that is, a closed circuit is formed among the first conductive layer 111, the second conductive layer 112, and the power source S, and therefore generating an electric field (such as a vertical electric field)). At this time, because the liquid-crystal layer 130 is affected by the vertical electric field, at least a part of the liquid-crystal layer 130 corresponding to the pressed writing area WA is arranged approximately perpendicular to the first substrate 101 and returns to the transparent state. In this way, the writable device 100 can return to the transparent state in which no information is written, thereby achieving the clearing function. In other words, in the clear state, exerting a cross-voltage (the vertical electric field is generated due to the potential difference between the first conductive layer 111 and the second conductive layer 112) to at least a part of the liquid-crystal layer 130 corresponding to the pressed writing area WA makes the liquid-crystal layer 130 is in the transparent state. With the above design of using positive-type cholesteric liquid-crystal and the vertically oriented first alignment layer 121 (or the second alignment layer 122), the time it takes to return to the initial state (that is, clearing the written information) can be reduced, and therefore improving the convenience of use of the writable device 100.

FIG. 2A shows a partially enlarged schematic view of the writable device 100 in accordance with some embodiments of the present disclosure. It should be noted that, for the purpose of detailed explanation, the liquid-crystal molecules 131 in the liquid-crystal layer 130 are enlarged, and it is not intended to represent the actual size of the liquid-crystal molecules 131. As shown in FIG. 2A, the liquid-crystal molecules 131 may have a macro axis A. A pretilt angle θ of the liquid-crystal layer 130 may, for example, be defined as the angle between the macro axis A and the surface of the first alignment layer 121 (or the surface of the second alignment layer 122). In some embodiments, the liquid-crystal molecules 131 of the liquid-crystal layer 130 adjacent to the first alignment layer 121 (or the second alignment layer 122) have, for example, the pretilt angle θ. The pretilt angle θ may be greater than 70° and less than 90°, but the present disclosure is not limited thereto. In some embodiments, the pretilt angle θ may be greater than 80° and less than 90°. In some embodiments, the pretilt angle θ may be greater than 75° and less than 85°. In some embodiments, the pretilt angle θ may be greater than 77° and less than 83°. In other words, the liquid-crystal molecules 131 may be substantially perpendicular to the surface of the first alignment layer 121 (or the surface of the second alignment layer 122), thereby defining the first alignment layer 121 and the second alignment layer 122 as vertical oriented. In some embodiments, the pretilt angle θ of the liquid-crystal layer 130 adjacent to the first alignment layer 121 may be the same as or different from the pretilt angle θ of the liquid-crystal layer 130 adjacent to the second alignment layer 122.

FIG. 2B shows a partially enlarged schematic view of the writable device 200 in accordance with some embodiments of the present disclosure. It should be understood that the elements of the writable device 200 shown in this embodiment may be the same or similar to those of the writable device 100 shown in FIGS. 1A to 1C. These elements will be labeled using the same or similar reference numerals, and will not be explained in detail below. As shown in FIG. 2B, the writable device 200 may include a first substrate 101, a second substrate 102, a first conductive layer 111, a second conductive layer 112, a first alignment layer 121, a second alignment layer 122 and a liquid-crystal layer 130 that is between the first alignment layer 121 and the second alignment layer 122. In the present embodiment, the writable device 200 may further include a spacer 150 that is disposed between the first substrate 101 and the second substrate 102 or between the first alignment layer 121 and the second alignment layer 122. In some embodiments, the spacer 150 may contact the first alignment layer 121 and/or the second alignment layer 122, but the present disclosure is not limited thereto. In some embodiments, the spacer 150 may contact the sealant 140, but the present disclosure is not limited thereto. In some embodiments, the first alignment layer 121 and the second alignment layer 122 are spaced apart by a distance (for example, the distance d shown in FIG. 1A) in the Z-axis direction via the spacer 150.

In some embodiments, in the arrangement direction (for example, substantially parallel to the Z-axis) of the first substrate 101 and the second substrate 102, the spacer 150 may have a thickness T1. For example, the thickness T1 is measured in the Z-axis direction and defined as the maximum thickness of spacer 150. In some embodiments, the ratio of the thickness T1 to the pitch of the liquid-crystal molecules 131 is greater than or equal to 5 and less than or equal to 20, but the present disclosure is not limited thereto. In some embodiments, the ratio of the thickness T1 to the pitch of the liquid-crystal molecules 131 is greater than or equal to 7 and less than or equal to 18. In some embodiments, the ratio of the thickness T1 to the pitch of the liquid-crystal molecules 131 is greater than or equal to 9 and less than or equal to 16. In some embodiments, the ratio of the thickness T1 to the pitch of the liquid-crystal molecules 131 is greater than or equal to 10 and less than or equal to 15. With the above configuration of the thickness T1 of the spacer 150 and the pitch of the liquid-crystal molecules 131, the color of the writable device 200 can be darker during writing, thereby improving the legibility of the written information, and the written color can be, for example, tuned according to the color of the dye added to the liquid-crystal layer 130. If the value of the distance d and the pitch of the liquid-crystal molecules 131 is too large and exceeds the above range, the liquid-crystal molecules 131 may not be easily restored by the electric field, making it difficult for the writable device 200 to return to its initial state.

FIG. 3 shows a schematic cross-sectional view of the writable device 300 in accordance with some embodiments of the present disclosure. It should be understood that the writable device 300 shown in this embodiment may include elements that are the same or similar to those of the writable device 100 shown in FIGS. 1A to 1C. These elements will be labeled using the same or similar reference numerals, and will not be explained in detail below. As shown in FIG. 3, the writable device 300 may include a first substrate 101, a second substrate 102, a first conductive layer 111, a second conductive layer 112, a first alignment layer 121, a second alignment layer 122, and a liquid-crystal layer 130 that is disposed between the first alignment layer 121 and the second alignment layer 122. In the present embodiment, the liquid-crystal layer 130 may include liquid-crystal molecules 132, such as polymer-stabilized cholesteric liquid-crystal texture (PSCT), but the present disclosure is not limited thereto. By adding polymer to the liquid-crystal layer 130, the liquid-crystal molecules 132 can be arranged more perpendicular to the surface of the first substrate 101 in the initial state, thereby making the liquid-crystal layer 130 more transparent in the initial state and improving the transmittance. Alternatively, the difference between the initial state and the writing state of the writable device 300 can be further improved, thereby improving the legibility of the written information.

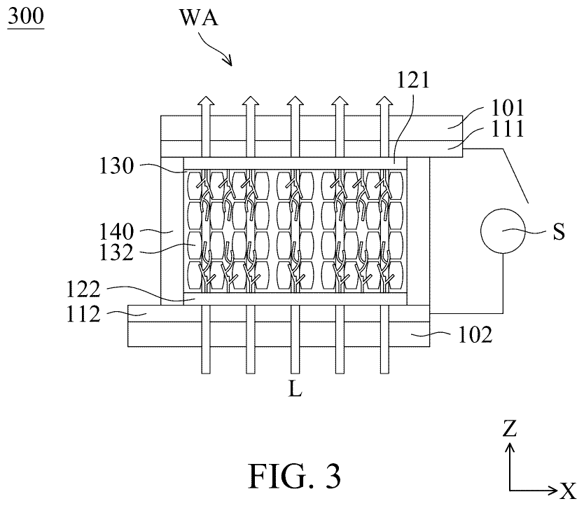

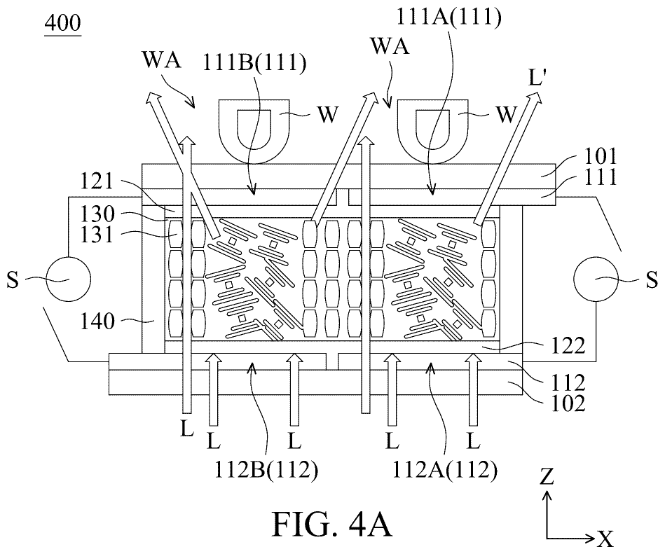

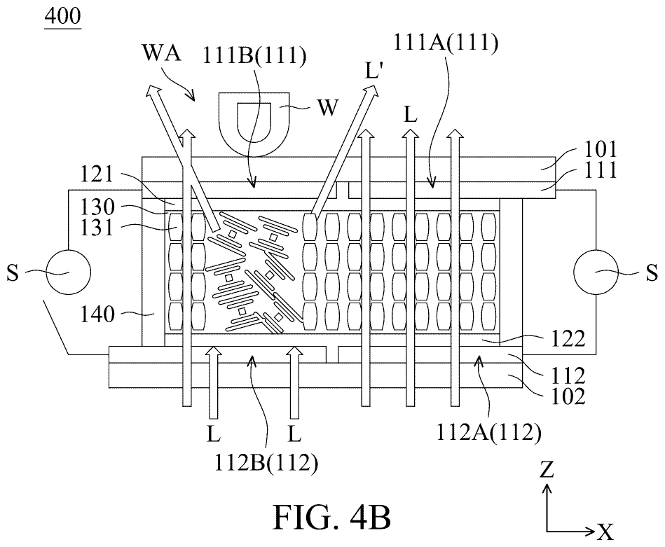

FIGS. 4A to 4B show schematic cross-sectional views of the writable device 400 in accordance with some embodiments of the present disclosure. It should be understood that the writable device 400 shown in this embodiment may include the elements that are the same or similar to those of the writable device 100 shown in FIGS. 1A to 1C. These elements will be labeled using the same or similar reference numerals, and will not be explained in detail below. As shown in FIGS. 4A and 4B, the writable device 400 may include a first substrate 101, a second substrate 102, a first conductive layer 111, a second conductive layer 112, a first alignment layer 121, a second alignment layer 122, and a liquid-crystal layer 130 that is disposed between the first alignment layer 121 and the second alignment layer 122. In the present embodiment, the first conductive layer 111 may be divided into a plurality of portions that are electrically independent (such as portions 111A and 111B, but not limited thereto). Similarly, the second conductive layer 112 may be divided into a plurality of portions that are electrically independent (such as portions 112A, 112B, but not limited thereto). The portions (such as the portions 112A, 112B) of the second conductive layer 112 respectively correspond to, for example, the first portion (for example, the portions 111A, 111B) of conductive layer 111. The portions of the second conductive layer 112 (such as the portions 112A and 112B) corresponding to the portions (such as the portions 111A and 111B) of the first conductive layer 111 may refer to that the second conductive layer 112 may at least partially overlap the first conductive layer 111 in the Z-axis direction. With the above configuration, the pressed writing area WA can be divided into multiple portions, and these portions can be controlled independently.

To be more specific, FIG. 4A shows in the writing state, and the liquid-crystal layer 130 corresponding to the pressed writing area WA is in the scattering state. Specifically, in the writing state, neither the first conductive layer 111 (such as the portions 111A, 111B) nor the second conductive layer 112 (such as the portions 112A, 112B) are electrically connected to the corresponding power source S (that is disconnected to the power supply S). At this time, the portion of the liquid-crystal layer 130 affected by the pressing W can be in the scattering state (that is, the liquid-crystal layer 130 corresponding to the pressed writing area WA can be in the scattering state), so the incident light L passing through the pressed writing area WA is scattered by, for example, the liquid-crystal layer 130 and changes the traveling direction of the incident light L. As a result, the liquid-crystal layer 130 in the pressed writing area WA appears in the mist state, and the liquid-crystal layer 130 outside the pressed writing area WA is in the transparent state. If at least one dye is added to the liquid-crystal layer 130, since the macro axis of the dye may be modulated along with the arrangement of the macro axis of the liquid-crystal molecules 131, most of the incident light L corresponding to the pressed writing area WA is absorbed by the dye. Only the light corresponding to the color of the dye is not absorbed and passes through the liquid-crystal layer 130. Meanwhile, the pressed writing area WA shows the color of the dye, and outside the pressed writing area WA appears in the transparent state, thereby achieving the writing function.

FIG. 4B shows in the clear state, for example, the portion 111A of the first conductive layer 111 and the portion 112A of the second conductive layer 112 are electrically connected to the power source S (that is, a closed circuit is formed among the portion 111A, the portion 112A and the power source S, generating an electric field (such as a vertical electric field)), so that the liquid-crystal molecules 131 located between the portion 111A and the portion 112A are affected by the vertical electric field and are arranged substantially perpendicular to the surface of the first substrate 101. For example, the liquid-crystal molecules 131 in this area are transparent, and they return to their original arrangement (i.e. the initial state). In addition, the portion 111B of the first conductive layer 111 and the portion 112B of the second conductive layer 112 are not electrically connected to the power source S (that is, an open circuit is formed among the portion 111B, the portion 112B and the power source S). Therefore, the liquid-crystal molecules 131 still remain scattered in the written state, thereby achieving a local clear function. However, the present disclosure is not limited thereto. In other embodiments (not shown), the portion 111B and the portion 112B are electrically connected to the power supply S, for example, so that the liquid-crystal molecules 131 between the portion 111B and the portion 112B are affected by the vertical electric field and arranged substantially perpendicular to the surface of the first substrate 101, that is, in the transparent state.

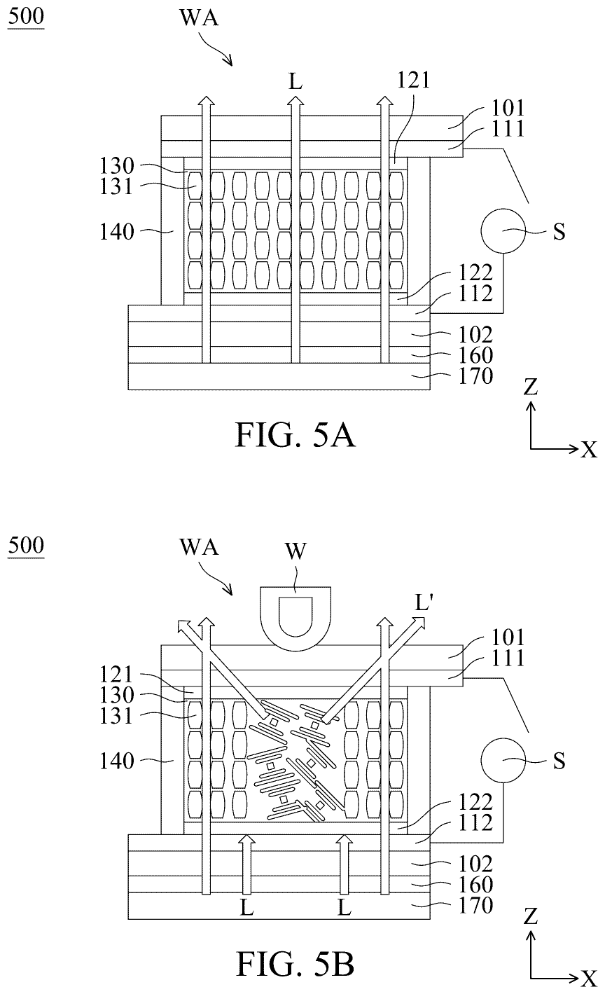

FIGS. 5A to 5B show schematic cross-sectional views of the writable device 500 in accordance with some embodiments of the present disclosure. It should be understood that the writable device 500 shown in the present embodiment may include the elements which are the same or similar to those of the writable device 100 shown in FIGS. 1A to 1C. These elements will be labeled by the same or similar reference numerals, and will not be explained in detail below. In the present embodiment, the writable device 500 may further include an attachment member 160 that is attached to the transparent element 170 (or a color-adjustable or non-color-adjustable element that may replace the transparent element 170 and is not labeled), The transparent element 170 includes, for example, windows, optical lenses, transparent partitions, other suitable transparent elements, or combinations thereof, but the present disclosure is not limited thereto. In some embodiments, the attachment member 160 can be used to bond (or attach) the second substrate 102 (or the first substrate 101) and the transparent element 170 (such as a window). The window can be suitable for buildings, vehicles (cars, ships, etc.), or other situations, but the present disclosure is not limited thereto. In this way, the writable device 500 can be used as a general transparent element 170 (such as a window) in the initial state, and in the writing state (as shown in FIG. 5B), it can also record the user's written (input) information. The writing method is the same as the one described above.

It should be noted that although the incident light L in the above embodiments of the present disclosure is mainly the incident light L emitted from the second substrate 102 to the liquid-crystal layer 130, the present disclosure is not limited thereto. Other incident lights (not shown) may also be emitted from the first substrate 101 to the liquid-crystal layer 130.

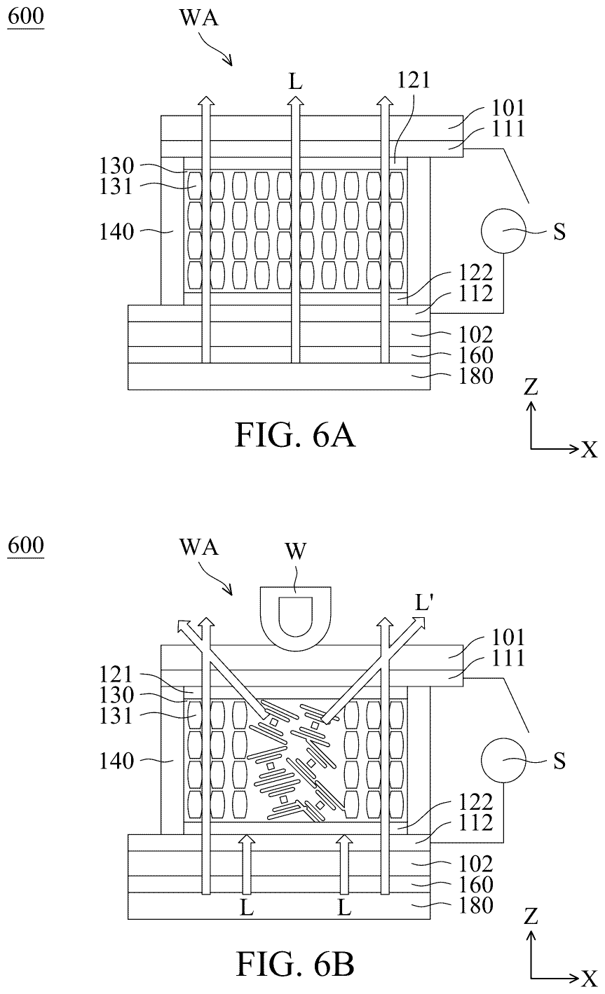

FIGS. 6A to 6B show schematic cross-sectional views of the writable device 600 in accordance with some embodiments of the present disclosure. It should be understood that the writable device 600 shown in this embodiment may include the elements which are the same or similar to those of the writable device 100 shown in FIGS. 1A to 1C. These elements will be labeled by the same or similar reference numerals, and will not be explained in detail below. As shown in FIGS. 6A and 6B, the writable device 600 may include a first substrate 101, a second substrate 102, a first conductive layer 111, a second conductive layer 112, a first alignment layer 121, and a second alignment layer 122, and a liquid-crystal layer 130 that is disposed between the first alignment layer 121 and the second alignment layer 122. In the present embodiment, the writable device 600 may further include an attachment member 160 that is attached to the display 180. In some embodiments, the attachment member 160 may be configured to bond the second substrate 102 (or the first substrate 101) and the display 180, but the present disclosure is not limited thereto. For example, the display 180 may be a display suitable for various electronic devices, such as a transparent display, a reflective display, a non-self-luminous display or a self-luminous display, but the present disclosure is not limited thereto. As a result, the writable device 600 can be used as a general display in the initial state (as shown in FIG. 6A), and in the writing state (as shown in FIG. 6B), it can also record the information written (input) by users. In other embodiments (not shown), the display 180 may be replaced by other electronic devices (such as a touch device, a detection device, a light-emitting device, but not limited thereto).

It should be noted that although the incident light L in the embodiments of the present disclosure is mainly the incident light L emitted from the second substrate 102 to the liquid-crystal layer 130, the present disclosure is not limited thereto. Other incident lights (not shown) may also be emitted from the first substrate 101 to the liquid-crystal layer 130. It should be noted that the direction of incident light may vary depending on the type of display. For example, if it is a transparent display, the direction of the incident light may include the incident light L emitted from the second substrate 102 to the liquid-crystal layer 130 and the incident light (not shown) emitted from the first substrate 101 to the liquid-crystal layer 130. However, the present disclosure is not limited thereto. For example, if it is a reflective display or a non-self-luminous display, the direction of the incident light may include incident light (not shown) emitted from the first substrate 101 to the liquid-crystal layer 130, but the present disclosure is not limited thereto.

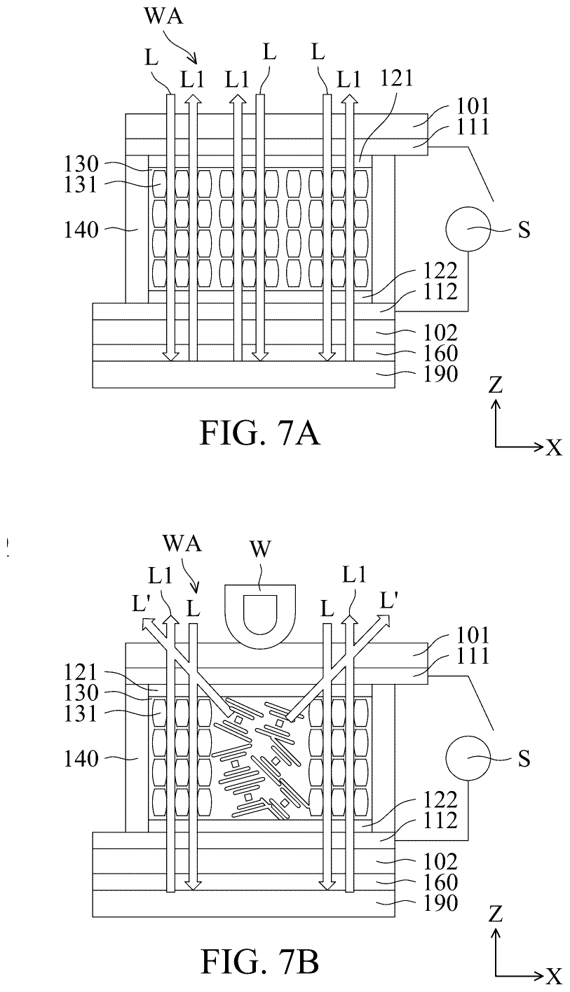

FIGS. 7A to 7B show schematic cross-sectional views of the writable device 700 in accordance with some embodiments of the present disclosure. It should be understood that the writable device 700 shown in this embodiment may include the elements which are the same or similar to those of the writable device 100 shown in FIGS. 1A to 1C. These elements will be labeled by the same or similar reference numerals, and will not be explained in detail below. As shown in FIGS. 7A and 7B, the writable device 700 may include a first substrate 101, a second substrate 102, a first conductive layer 111, a second conductive layer 112, a first alignment layer 121, a second alignment layer 122, and a liquid-crystal layer 130 that is disposed between the first alignment layer 121 and the second alignment layer 122. In the present embodiment, the writable device 700 may further include an attachment member 160 that is attached to a reflective element 190 (such as a mirror, but not limited thereto). In some embodiments, the attachment member 160 may be configured to bond the second substrate 102 (or the first substrate 101) and the reflective element 190, but the present disclosure is not limited thereto. For example, the reflective element 190 can be used as a reflective layer or a reflective plate to reflect light (for example, the incident light L), and the light L1 reflected by the reflective element 190 can be viewed by users. Accordingly, the writable device 700 can be used as a general mirror in the initial state (as shown in FIG. 7A), and can further record the information written (input) by users in the writing state (as shown in FIG. 7B).

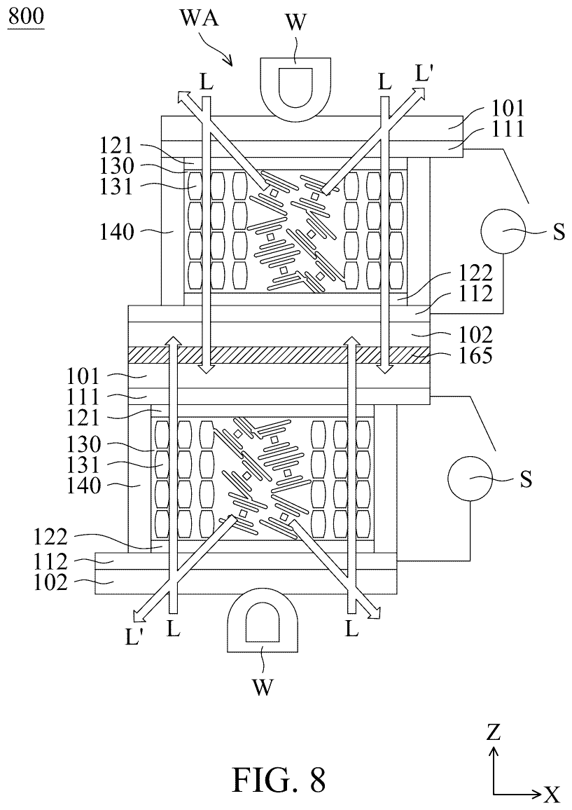

FIG. 8 shows a schematic cross-sectional view of the writable device 800 in accordance with some embodiments of the present disclosure. It should be understood that the writable device 800 shown in this embodiment may include the elements which are the same or similar to those of the writable device 100 shown in FIGS. 1A to 1C. These elements will be labeled by the same or similar reference numerals, and will not be explained in detail below. As shown in FIG. 8, the writable device 800 may include a plurality of writable devices (referring to the writable device 100 shown in FIGS. 1A to 1C), each of which includes a first substrate 101, a second substrate 102, a first conductive layer 111, a second conductive layer 112, a first alignment layer 121, a second alignment layer 122, and a liquid-crystal layer 130 that is disposed between the first alignment layer 121 and the second alignment layer 122. In the present embodiment, the adhesive layer 165 may be used to bond two writable devices as shown in FIGS. 1A to 1C. In this way, the writing function can be implemented on opposite sides of the writable device 800. In some embodiments, the same or different color dyes may be added to the liquid-crystal layers 130 of the two writable devices. In some embodiments, dyes may be added to at least one of the liquid-crystal layers 130 of the two writable devices. In some embodiments, the adhesive layer 165 may include a transparent or opaque adhesive layer. When the adhesive layer 165 is transparent, the writing information of the writable devices on both sides can be integrated. When the adhesive layer 165 is opaque, the risk of interference between written information recorded on both sides may be reduced, but the present disclosure is not limited thereto. In some embodiments, information recorded on both sides of the writable device 800 can be cleared independently, but the present disclosure is not limited thereto.

It should be understood that although the above embodiments merely illustrate part of the configuration of the writable device, those skilled in the art should be able to add other optical layers and/or optical elements in the structures described in the present disclosure so as to enhance the display and/or touch effects based on the teachings of the present disclosure. These configurations derived from the present disclosure are also included in the scope of the present disclosure. In addition, the present disclosure also provides several different writable devices. Those skilled in the art should be able to arbitrarily combine or arrange these writable devices without violating the teachings of the present disclosure, and all these arrangements are within the scope of the present disclosure.

As set forth above, embodiments of the present disclosure provide a writable device including alignment layers that are vertically oriented. Specifically, by providing the vertically oriented alignment layers, the liquid-crystal layer of the writable device can be in a transparent state in the initial state, thereby increasing the applicable range of the writable device, which can be bonded to any component, for example. In addition, in the writing state, the liquid-crystal molecules in the liquid-crystal layer will be randomly arranged in a scattering state (that is, shown in a mist state). If dyes are added to the liquid-crystal, the pressed writing area will show the color of the dyes and achieve writing function. In addition, in the clear state, by connecting to the power supply (making the liquid-crystal layer be affected by the electric field), at least a part of the liquid-crystal layer corresponding to the pressed writing area is in the transparent state, so as to clear the written information. In this way, the writable device can be reset to its original state in a short period of time, thereby improving the convenience of use of the writable device. Since the writable device of the present disclosure is transparent in the initial state, it can be applied to any transparent element, color-adjustable or non-color-adjustable element, display or reflective element, and can meet users' various needs.

While the embodiments and the advantages of the present disclosure have been described above, it should be understood that those skilled in the art may make various changes, substitutions, and alterations to the present disclosure without departing from the spirit and scope of the present disclosure. It should be noted that different embodiments may be arbitrarily combined as other embodiments as long as the combination conforms to the spirit of the present disclosure. In addition, the scope of the present disclosure is not limited to the processes, machines, manufacture, composition, devices, methods and steps in the specific embodiments described in the specification. Those skilled in the art may understand existing or developing processes, machines, manufacture, compositions, devices, methods and steps from some embodiments of the present disclosure. Therefore, the scope of the present disclosure includes the aforementioned processes, machines, manufacture, composition, devices, methods, and steps. Furthermore, each of the appended claims constructs an individual embodiment, and the scope of the present disclosure also includes every combination of the appended claims and embodiments.

What is claimed is:

1. A writable device, comprising:
a first substrate;
a second substrate opposite the first substrate;
a liquid-crystal layer disposed between the first substrate and the second substrate;
a first alignment layer disposed between the first substrate and the liquid-crystal layer; and
a second alignment layer disposed between the second substrate and the liquid-crystal layer;
wherein the first alignment layer and the second alignment layer are vertically oriented,
wherein in an initial state, the liquid-crystal layer is in a transparent state, in a writing state, the liquid-crystal layer corresponding to a pressed writing area is in a scattering state,
in a clear state, at least a part of the liquid-crystal layer corresponding to the pressed writing area is in the transparent state.

2. The writable device as claimed in claim 1, wherein in the clear state, the at least part of the liquid-crystal layer corresponding to the pressed writing area is in the transparent state by exerting a cross-pressure.

3. The writable device as claimed in claim 2, wherein the liquid-crystal layer comprises cholesteric positive liquid-crystal.

4. The writable device as claimed in claim 3, wherein at least one dye is added to the liquid-crystal layer.

5. The writable device as claimed in claim 3, wherein there is a distance between the first alignment layer and the second alignment layer, and the cholesteric positive liquid-crystal has a pitch, and a ratio of the distance to the pitch is greater than or equal to 5 and less than or equal to 20.

6. The writable device as claimed in claim 3, wherein a spacer is disposed between the first substrate and the second substrate, in an arrangement direction of the first substrate and the second substrate, the spacer has a thickness, the cholesteric positive liquid-crystal has a pitch, and a ratio of the thickness to the pitch is greater than or equal to 5 and less than or equal to 20.

7. The writable device as claimed in claim 6, wherein the spacer is in contact with the first alignment layer and the second alignment layer.

8. The writable device as claimed in claim 6, wherein the spacer has a rounded profile in a cross-sectional view.

9. The writable device as claimed in claim 1, wherein the liquid-crystal layer adjacent to the first alignment layer has a pretilt angle, and the pretilt angle is greater than 70° and less than 90°.

10. The writable device as claimed in claim 1, wherein the writable device is attached to a transparent element, a display or a reflective element via an attachment member.

11. The writable device as claimed in claim 10, wherein the attachment member is bonded to the first substrate or the second substrate.

12. The writable device as claimed in claim 1, wherein a thickness of the first substrate is greater than or equal to 0.2 mm and less than or equal to 30 mm.

13. The writable device as claimed in claim 1, wherein the liquid-crystal layer comprises polymer-stabilized cholesteric liquid-crystal.

14. The writable device as claimed in claim 1, wherein the first substrate comprises glass, polymer materials, or ceramics.

15. The writable device as claimed in claim 1, further comprising a sealant disposed between the first substrate and the second substrate, wherein the sealant surrounds the liquid-crystal layer.

16. The writable device as claimed in claim 1, further comprising a first conductive layer disposed between the first substrate and the first alignment layer, and the first conductive layer is selectively electrically connected to a power supply.

17. The writable device as claimed in claim 16, wherein the first conductive layer is divided into a plurality of first portions that are electrically independent.

18. The writable device as claimed in claim 17, further comprising a second conductive layer disposed between the second substrate and the second alignment layer, and the second conductive layer is divided into a plurality of second portions that are electrically independent.

19. The writable device as claimed in claim 18, wherein the second portions at least partially overlap the first portions in a normal direction of the first substrate.

20. The writable device as claimed in claim 1, further comprising an adhesive layer disposed over the first substrate or the second substrate and configured to bond another writable device.
